(19) United States
(12) Patent Application Publication
(10) Pub. No.: US 2025/0371339 A1
(43) Pub. Date: Dec. 4, 2025

(54) METHOD, APPARATUS, DEVICE, AND MEDIUM FOR TRAINING A MACHINE LEARNING MODEL

(71) Applicants: Douyin Vision Co., Ltd., Beijing (CN); Lemon Inc., Grand Cayman (KY)

(72) Inventors: Yimin JIANG, Beijing (CN); Juncai LIU, Beijing (CN); Yibo ZHU, Los Angeles, CA (US)

(21) Appl. No.: 18/876,476

(22) PCT Filed: Sep. 21, 2023
(86) PCT No.: PCT/CN2023/120501

§ 371 Date: Dec. 18, 2024

(30) Foreign Application Priority Data
Oct. 30, 2022 (CN) 202211341102.0

(51) Int. Cl. G06N 3/08; G06N 3/045; G06N 3/0499

(52) U.S. Cl. CPC G06N 3/08; G06N 3/045; G06N 3/0499

(57) ABSTRACT

Provided are a method, an apparatus, a device, and a medium for training a machine learning model. The machine learning model includes a first sub-model and a second sub-model, the first sub-model is located at a first compute node in a computing system, and the second sub-model is located at a second compute node in the computing system. In the method, at the first compute node, a first set of training data for training the machine learning model is received. The second sub-model is obtained from the second compute node. The first set of training data is input into the first sub-model and the obtained second sub-model respectively to determine a first update parameter for updating the first sub-model and a second update parameter for updating the second sub-model. The second update parameter is transmitted to the second compute node.

The present application claims priority to Chinese Patent Application No. 202211341102.0, filed on Oct. 30, 2022, and entitled “METHOD, APPARATUS, DEVICE, AND MEDIUM FOR TRAINING A MACHINE LEARNING MODEL”, the entirety of which is incorporated herein by reference.

### FIELD

Example implementations of the present disclosure are generally related to machine learning, and in particular to a method, an apparatus, a device, and a computer-readable storage medium for training a machine learning model.

### BACKGROUND

A machine learning model may be utilized to perform tasks in a variety of application environments. As tasks to be processed are complicated, the structure of the machine learning model also becomes more complex and the size also increases, which results in difficulties in training the machine learning model at a single compute node. A distributed training method has been proposed to train a machine learning model at a plurality of compute nodes, however, training data needs to be transmitted between respective compute nodes during training. The transmission process, on the one hand, needs to occupy a large amount of bandwidth, and on the other hand, a blocking training process causes respective compute nodes to wait to receive training data before determining an update parameter of the model. In this case, how to use a plurality of compute nodes to train a machine learning model in a more efficient manner becomes a problem to be solved urgently.

### SUMMARY

In a first aspect of the present disclosure, a method for training a machine learning model is provided. The machine learning model comprising a first sub-model and a second sub-model, the first sub-model being located at a first compute node in a computing system, and the second sub-model being located at a second compute node in the computing system. In the method, at the first compute node, a first set of training data for training the machine learning model is received. The second sub-model is obtained from the second compute node. The first set of training data is input into the first sub-model and the obtained second sub-model respectively to determine a first update parameter for updating the first sub-model and a second update parameter for updating the second sub-model.

In a second aspect of the present disclosure, an apparatus for training a machine learning model is provided. The machine learning model comprises a first sub-model and a second sub-model. The first sub-model is located at a first compute node in a computing system, and the second sub-model is located at a second compute node in the computing system. The apparatus comprises a receiving module configured to receive a first set of training data for training the machine learning model; an obtaining module configured to obtain the second sub-model from the second compute node; a determining module configured to input the first set of training data into the first sub-model and the obtained second sub-model respectively to determine a first update parameter for updating the first sub-model and a second update parameter for updating the second sub-model; and a transmitting module configured to transmit the second update parameter to the second compute node.

In a third aspect of the present disclosure, there is provided an electronic device. The device comprises at least one processing unit; and at least one memory coupled to the at least one processing unit and stores an instruction for execution by the at least one processing unit. The instruction, when executed by the at least one processing unit, causes the device to implement the method of the first aspect.

In a fourth aspect of the present disclosure, there is provided a computer-readable storage medium having stored thereon a computer program which, when executed by a processor, implements the method of the first aspect.

It should be understood that what is described in the Summary is not intended to limit the key features or essential features of the embodiments of the present disclosure, nor is it intended to limit the scope of the present disclosure. Other features of the present disclosure will be readily appreciated from the following description.

### BRIEF DESCRIPTION OF THE DRAWINGS

The above and other features, advantages, and aspects of various embodiments of the present disclosure will become more apparent with reference to the following detailed description taken in combination with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a block diagram of a process for training a machine learning model according to one embodiment;

FIG. 3 illustrates a block diagram of a process for training a machine learning model according to some implementation of the present disclosure;

FIG. 4 illustrates a block diagram of the structure of a computing system for training a machine learning model according to some implementations of the present disclosure;

FIG. 5 illustrates a block diagram of topology between a computing device and a compute node according to some implementations of the present disclosure;

FIG. 6 illustrates a block diagram of a process for obtaining sub-models from compute nodes located on the same computing device according to some implementations of the present disclosure;

FIG. 7 illustrates a block diagram of a comparison of a plurality of training processes according to some implementations of the present disclosure;

FIG. 8A illustrates a block diagram of the timing of transmission of a sub-model among a plurality of compute nodes according to some implementations of the present disclosure;

FIG. 8B illustrates a block diagram of the timing of transmission of a sub-model among a plurality of compute nodes according to some implementations of the present disclosure;

FIG. 9 illustrates a block diagram of a process for obtaining sub-models from compute nodes located on different computing devices according to some implementations of the present disclosure;

FIG. 10A illustrates a block diagram of a first phase of a process of obtaining a plurality of sub-models from different computing devices according to some implementations of the present disclosure;

FIG. 10B illustrates a block diagram of a second phase of the process of obtaining a plurality of sub-models from different computing devices according to some implementations of the present disclosure;

FIG. 11 illustrates a flow chart of a method for training a machine learning model according to some implementations of the present disclosure;

FIG. 12 illustrates a block diagram of an apparatus for training a machine learning model according to some implementations of the present disclosure; and

FIG. 13 illustrates an electronic device in which one or more implementations of the present disclosure may be implemented.

### DETAILED DESCRIPTION

Although certain implementations of the present disclosure are shown in the drawings, it should be understood that the present disclosure may be implemented in various forms and should not be construed as limited to the implementations set forth herein; rather, these implementations are provided for a thorough and complete understanding of the present disclosure. It should be understood that the drawings and implementations of the present disclosure are only for exemplary purposes and are not intended to limit the scope of protection of the present disclosure.

In the description of implementations of the present disclosure, the term “comprising” and its similar language should be understood as open-ended comprising, that is, “comprising but not limited to”. The term “based on” should be read as “based at least in part on” The term “one implementation” or “the implementation” should be read as “at least one implementation. “The term “some implementations” should be understood as “at least some implementations.” Other explicit and implicit definitions may also be included below. As used herein, the term “model” may denote an association between respective data. The association may be obtained, for example, based on a variety of technical solutions that are currently known and/or will be developed in the future.

It is to be understood that the data involved in the technical solution (including but not limited to the data itself, the acquisition or use of the data) should comply with the requirements of the corresponding legal regulations and related provisions.

It should be understood that, before the technical solutions disclosed in the embodiments of the present disclosure are used, the user should be informed of the type of personal information, the usage range, the usage scenario, and the like related to the present disclosure and the authorization of the user should be obtained in an appropriate manner according to relevant legal regulations.

For example, in response to receiving an active request from a user, prompt information is sent to the user to explicitly prompt the user that an operation requested by the user will require acquisition and use of personal information of the user. Thereby, the user may autonomously select, according to the prompt information, whether to provide personal information to software or hardware such as an electronic device, an application program, a server, or a storage medium that performs the operations of the technical solutions of the present disclosure.

As an optional but non-limiting implementation, a manner of sending prompt information to a user in response to receiving an active request from the user may be, for example, a manner of popping up a window, and the prompt information may be presented in a text manner in the pop-up window. In addition, the pop-up window may further carry a selection control for the user to select “agree” or “do not agree” to provide personal information to the electronic device.

It can be understood that the above processes of notifying and obtaining the user authorization are only illustrative, and do not limit the implementation of the present disclosure, and other methods meeting relevant legal regulations may also be applied to the implementation of the present disclosure.

As used herein, the term “in response to” refers to a state in which a corresponding event occurs or a condition is satisfied. It will be appreciated that the timing of the execution of a subsequent action that is performed in response to the event or condition and the time at which the event occurs or the condition is established are not necessarily strongly correlated. For example, in some cases, subsequent actions may be performed immediately upon the occurrence of an event or upon satisfaction of a condition; in other cases, subsequent actions may be performed only after a period of time has passed after an event occurs or a condition is established.

### Example Environment

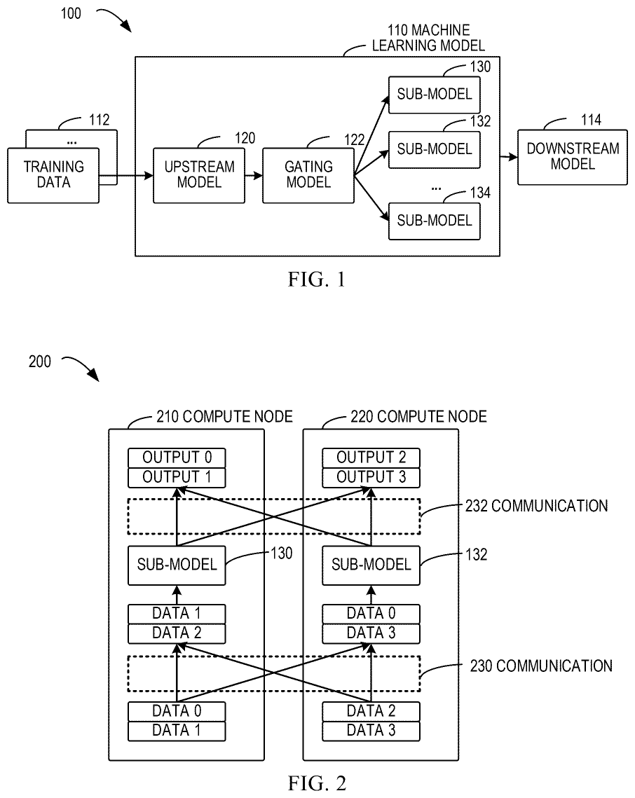

FIG. 1 illustrates a block diagram of an example environment 100 in which implementations of the present disclosure can be implemented. In the environment 100 of FIG. 1, a machine learning model 110 may be trained using training data (for example, tokens) 112. Here, the machine learning model 110 may be a model implemented based on a Mixture of Experts (MoE). The MoE may decompose a task into several subtasks, and a corresponding sub-model (also referred to as an expert model) is trained for each subtask. A gating model may be utilized to determine which sub-model to activate. As shown in FIG. 1, the MoE-based machine learning model 110 may include an upstream model 120, a gating model 122, and a plurality of sub-models 130, 132, . . . , and 134. Further, the output of the machine learning model 110 may be used as input for a downstream model 114.

Due to the increased training overhead, it is difficult to train the machine learning model 110 at a single compute node. Currently, an “expert-centric” technical solution has been developed to train respective sub-models at a plurality of compute nodes. Briefly, a technical solution that is “expert-centered” refers to deploying a plurality of sub-models at a plurality of compute nodes, respectively. The locations of the sub-models are fixed and the training data is transmitted between respective compute nodes. FIG. 2 illustrates a block diagram 200 of a process for training a machine learning model according to one implementation. As shown in FIG. 2, the sub-model 130 may be deployed and trained at a compute node 210, and the sub-model 132 may be deployed and trained at a compute node 220. In particular, Data 0 and Data 1 may be input into the compute node 210, and Data 2 and Data 3 may be input into the compute node 220.

In the training process, respective sub-models need to use respective data to complete the training process. In this case, for a certain compute node, training data local to the compute node needs to be transmitted to other compute nodes. For example, the compute node 210 may need to transmit Data 0 to the compute node 220 to determine an update parameter for the sub-model 132 using Data 0 and Data 3 at the compute node 220. As another example, the compute node 220 may need to transmit Data 2 to the compute node 210 to determine an update parameter for the sub-model 130 using Data 1 and Data 2 at the compute node 220. At this point, it is necessary to perform an “all-to-all” communication 230 between the compute nodes 210 and 220, that is, to send all data at the compute node to all other compute nodes. Further, after the update parameters for the respective sub-models have been determined, an “all-to-all” communication 232 also needs to be performed to return the responsive update parameters to the compute nodes on which the respective sub-models are located.

It will be appreciated that FIG. 2 only schematically illustrates communications between two compute nodes 210 and 220, and communications between the plurality of compute nodes will occupy a significant amount of communication bandwidth when there are more compute nodes. Furthermore, since respective sub-models may start computing and determine the corresponding update parameter after receiving the training data, this causes respective compute nodes need to wait for the training data, which further increases the time overhead of the training phase. At this point, it is desirable to train the machine learning model with a plurality of compute nodes in a more efficient manner.

### Overview Process for Training a Machine Learning Model

In order to at least partially address the above-described deficiencies, according to one example implementation of the present disclosure, a method for training a machine learning model is proposed. With respect to the technical solution of “expert-centric” described in FIG. 2, a technical solution of “data-centric” is proposed. Briefly, the technical solution of “data-centric” refers to deploying a plurality of sub-models at a plurality of compute nodes, respectively, with the location of training data fixed and the sub-models being transmitted between compute nodes.

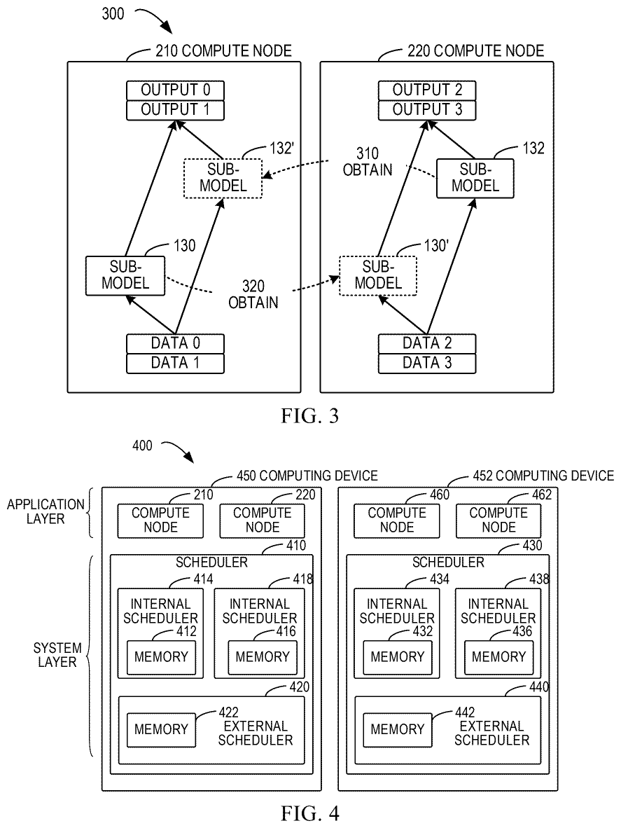

An overview of an example implementation according to the present disclosure is described with reference to FIG. 3, which illustrates a block diagram 300 of a process for training a machine learning model according to some implementations of the present disclosure. For ease of description, the machine learning model herein may include the sub-model 130 and the sub-model 132, and the computing system configured to perform a training task may include compute nodes 210 and 220. Sub-models 130 and 132 may be referred to as a first sub-model and a second sub-model, respectively, for ease of discrimination, and compute nodes 210 and 220 may be referred to as a first compute node and a second compute node, respectively. As shown in FIG. 3, the sub-model 130 may be deployed at the compute node 210, and the sub-model 132 may be deployed at the compute node 220.

Training tasks may be performed in a plurality of training phases, and a corresponding set of training data may be input into respective sub-models in each training phase. For example, in a training phase, at the compute node 210, a first set of training data (for example, comprising Data 0 and Data 1) for training the machine learning model may be received. The gating model in the machine learning model may determine which sub-module to be activated by the training data. As illustrated by an arrow 310, the compute node 210 may obtain the sub-model 132 from the compute node 220 as needed; and as illustrated by an arrow 320, the compute node 220 may obtain the sub-model 130 from the compute node 210 as needed.

At the compute node 210, a set of training data may be input into the sub-model 130 and an obtained sub-model 132′, respectively, to determine a first update parameter for updating the sub-model 130 and a second update parameter for updating the second sub-model 132. The update parameters for respective sub-models may be determined based on a variety of optimization approaches that are currently known and/or will be developed in the future. It will be appreciated that since each compute node maintains a respective local sub-model, the second update parameter needs to be transmitted to the local compute node 220 on which the sub-model 132 is located for the compute node 220 to update its local sub-model 132.

Similar to the process performed at the compute node 210 described above, at the compute node 220, a second set of training data (for example, comprising Data 2 and Data 3) for training the machine learning model may be received. The sub-model 130 may be obtained from the compute node 210, and the second set of training data is input into the obtained sub-model 130′ and sub-model 132, respectively, to determine the update parameter for updating the sub-model 130 and the update parameter for updating the second sub-model 132. Further, the update parameter for updating the sub-model 132 may be transmitted to the compute node 210.

It will be appreciated that FIG. 3 only schematically illustrates the deployment of two sub-models at two compute nodes, respectively. Alternatively, and/or in addition, the machine learning model may include more sub-models, at which point various sub-models may be deployed at more compute nodes. For example, a sub-model may be deployed at each compute node.

Generally speaking, data amount of a sub-model is generally far less than data amount of training data. Compared with the existing technical solutions of transmitting training data between a plurality of compute nodes, transmitting a sub-model instead of the training data between a plurality of compute nodes may greatly reduce transmission bandwidth and transmission time involved in training, thereby improving the overall performance of the training phase. Further, since the sub-model to be activated may be known in advance, the sub-model to be activated may be preloaded to the compute node. In this way, the time overhead of waiting for training data in the existing technical solutions may be further reduced, thereby further improving the efficiency of the training phase.

### Detailed Process of Training a Machine Learning Model

Having described an overview of the training process, more details of an example implementation according to the present disclosure will be described below with reference to FIG. 4. FIG. 4 illustrates a block diagram of the structure of a computing system 400 for training a machine learning model according to some implementations of the present disclosure. The training process may be performed in the computing system 400 as illustrated in FIG. 4, and the computing system 400 may include a plurality of computing devices 450 and 452. Each computing device may include a plurality of compute nodes, respectively. For example, the computing device 450 may include compute nodes 210 and 220, and the computing device 452 may include compute nodes 460 and 462. Here, the computing device may be, for example, a computing device with a central processing unit (CPU) in the computing system 400, and the compute node may be, for example, a graphical processing unit (GPU) in respective computing devices. For ease of differentiation, computing devices 450 and 452 may be referred to as a first computing device and a second computing device, respectively.

A plurality of sub-models in a machine learning model may be deployed respectively at a plurality of compute nodes, where the machine learning model may be implemented based on a hybrid expert system, and the plurality of sub-models may be a plurality of expert models in the hybrid expert system respectively. The training process may be performed in the computing system 400 shown in FIG. 4. In particular, the plurality of compute nodes may be located in an application layer for performing processes related to the training task itself. Further, the computing device 450 may include a scheduler 410 that may receive requests to obtain sub-models from respective compute nodes and obtain a desired sub-model from a specified location based on the request. The scheduler 410 may include an internal scheduler (with a memory 412 for the compute node 210) 414 and an internal scheduler (with a memory 416 for the compute node 220) 418 for the compute node 220, respectively. Further, the scheduler 410 may include an external scheduler 420 (with a memory 422 for the computing device 450).

Similarly, the computing device 452 may have a scheduler 430 that may include an internal scheduler (with a memory 432 for the compute node 460) 434 for the compute node 460, and an internal scheduler (with a memory 436 for the compute node 462) 438 for the compute node 462, respectively. Further, the scheduler 430 may include an external scheduler 440 (with a memory 442 for the computing device 452). Herein, respective schedulers are located at the system layer to manage the process of obtaining sub-models during the training process. In particular, internal schedulers 414, 418, 434, and 436 are configured to perform scheduling tasks within the computing device, and external schedulers 420 and 440 are configured to perform scheduling among the respective computing devices.

In the following, a specific training process utilizing the computing system 400 will be described merely as an example of the training process performed at the computing device 450. The sub-model 130 may be deployed at the compute node 210, and the sub-model 132 may be deployed at the compute node 220. The machine learning model may be trained iteratively in a plurality of phases, for example, in a training phase, the first set of training data for training the machine learning model may be received at the compute node 210. Because only the sub-model 130 exists locally at the compute node 210, it is necessary to obtain other sub-models to be activated from other compute nodes.

It will be appreciated that, based on the deployment of the sub-model, other sub-models may be located within the computing device 450 where the compute node 210 is located, or may be located outside of the computing device 450 where the compute node 210 is located. In this case, different obtaining flows are triggered respectively. It is to be understood that the gating model in the machine learning model may determine which sub-model will be activated by the training data, and the sub-model to be activated may be obtained in advance. For example, the sub-model may be obtained from a compute node with the sub-model to be activated at the starting time of respective training phases. For example, at the compute node 210, the sub-model 132 may be obtained from the compute node 220. In this way, waiting delay in the training process may be reduced, thereby improving the performance of the training process.

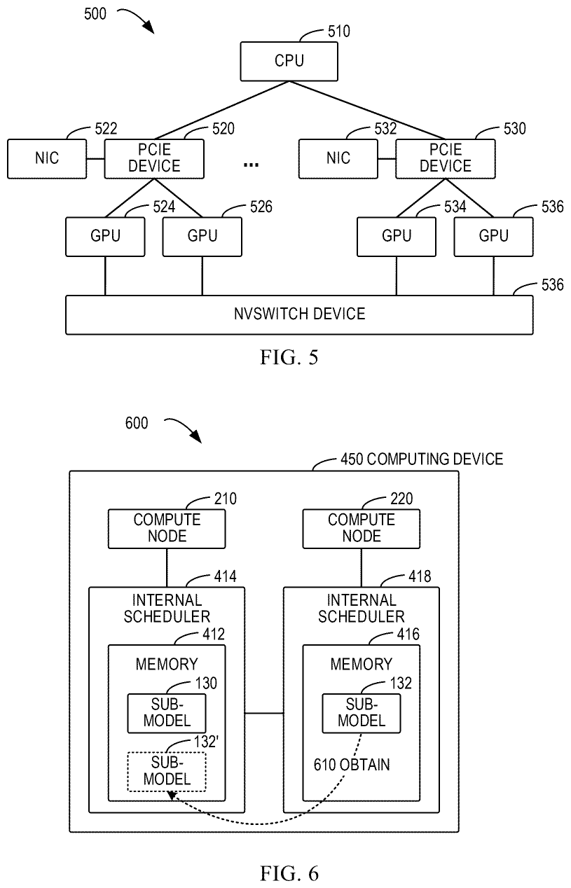

It will be appreciated that the first set of training data herein may include a large amount (for example, 1024 or more) of training data, although a single training data activates only a small number of sub-models, when the amount of training data is large, then these training data activates almost all of the sub-models. In this case, respective sub-models to be activated may be obtained in advance, thereby improving the overall performance of the training process. It will be appreciated that FIG. 4 only illustrates a simplified example where the computing device includes two compute nodes, and in an actual application environment, the computing device may include a plurality of compute nodes. For example, the computing device may include more compute nodes, and the computing device and GPU may be connected via different communication links. FIG. 5 illustrates a block diagram 500 of topology between a computing device and a compute node according to some implementations of the present disclosure.

As shown in FIG. 5, the computing device may include a CPU 510 and 8 GPUs (that is, GPUs 524, 526, . . . , 534, 536). GPUs 524 and 526 may be connected to the CPU 510 via a PCIE device 520, and the PCIE device 520 may further be connected to other computing devices via a Network Interface Controller (NIC) 522. Similarly, GPUs 534 and 536 may be connected to the CPU 510 via a PCIE device 530, and the PCIE device 530 may be further connected to other computing devices via a Network Interface Controller (NIC) 532. Further, respective GPUs may be connected via an NVSwitch device 536.

Here, a connection between two different computing devices via the NIC device may be referred to as a first type of communication link, a connection between a CPU and a GPU via the PCIE device may be referred to as a second type of communication link, and a connection between two GPUs via the NVSwitch device may be referred to as a third type of communication link. The three types of communication links may have different transmission speeds, and the transmission speed of the first type of communication link<the transmission speed of the second type of communication link<the transmission speed of the third type of communication link. In the process of obtaining the sub-model, the sub-model may be obtained respectively through different types of communication links based on different locations of the sub-model to be obtained.

In the following, obtaining the sub-model 132 from the compute node 220 will be described as an example. The compute node 210 may send a request to obtain a target sub-model (for example, the sub-model 132) to the scheduler 410, for example, the request may be added to an acquisition queue for processing by the scheduler 410. The scheduler 410 may invoke a scheduler for internal scheduling or a scheduler for external scheduling based on the location of the target sub-model.

An example of obtaining a sub-model from a compute node located within the same computing device is first described. Both the compute node 210 and the compute node 220 are located in the same computing device 450 in the computing system 400, and the internal scheduler 414 may be invoked to write the sub-model 132 from the memory 416 of the compute node 220 to the memory 412 of the compute node 210. Further details of the acquisition process are described with reference to FIG. 6, which illustrates a block diagram 600 of a process for obtaining sub-models from compute nodes located in the same computing device according to some implementations of the present disclosure. As shown in FIG. 6, the sub-model 132 is deployed at the compute node 220 (that is, in the memory 416 of the compute node 220). As illustrated by an arrow 610 in FIG. 6, the internal scheduler 414 may obtain the sub-model 132 from the memory 416 of the compute node 220 and store it into the memory 412 of the compute node 210 to form the sub-model 132′.

Although FIG. 6 only illustrates a case where the sub-model 132 is obtained in advance to the memory 412 of the compute node 210, alternatively, and/or in addition, one or more sub-models to be invoked may be loaded to the memory 412 in advance at the starting time point of the training phase. In this way, sub-models to be invoked may be prepared in advance, thereby reducing time delays during the training process due to acquisition of the sub-models.

It will be appreciated that there are typically limits on the capacity of the memory of respective compute nodes, and thus sub-models cannot be loaded to the memory without limitation. In general, the sizes of the plurality of sub-models in the machine learning model are similar (for example, having a threshold size), and a threshold number of sub-models that may be accommodated in the memory may be determined based on a comparison of the storage capacity of the memory and the threshold size. For example, assuming that the memory capacity is N times the size of the sub-model, then the threshold number is N. A “credit” may be set for respective memory to represent the number of sub-models the current memory may further accommodate. The credit may be set to the threshold capacity N of the memory at an initial phase. In the case of loading the sub-model to the memory, the credit may be decremented by one; In the case of releasing the sub-model from memory, the credit may be incremented by one.

According to an example implementation of the present disclosure, before writing the sub-model to the memory, whether the memory includes free space may be determined based on the credit. If it is determined that the number of sub-models in the memory 412 of the compute node 210 is below the threshold number, then there exists free space and the sub-model 132 may be written to the memory 412. In this way, it may be determined in a simple and efficient manner whether the sub-model may be written to the memory, thereby avoiding situations in which the writing process overwrites the sub-model being used in memory.

According to an example implementation of the present disclosure, sub-models in the memory that have no longer been used may be released. Assuming that the memory 412 of the compute node 210 includes the third sub-model of the machine learning model, if it is determined that the number of sub-models in the memory 412 is equal to the threshold number (that is, the memory 412 is full and cannot store other sub-models), it may be determined whether the existing sub-models in the memory 412 have been used up. If it is determined that an update parameter of the third sub-model in the memory 412 has been transmitted (that is, a relevant update gradient has been transmitted to the local compute node where the third sub-model is located), the third sub-model may be released from the memory 412. At this point, the released space may be used to store the sub-model 132, and the sub-model 132 may be written to the memory 412. By means of the example implementation of the present disclosure, a space in the memory may be shared among a plurality of sub-models through loading and releasing operations, thereby improving the utilization rate of the limited memory space. Further, when an idle space is included in memory, sub-models to be invoked may be constantly obtained in advance, thus reducing potential waiting delay.

Where the desired sub-model 132 has been obtained, the first set of training data may be input to the sub-model 130 and the obtained sub-model 132′, respectively, at the compute node 210 to determine the first update parameter for updating the sub-model 130 and the second update parameter for updating the sub-model 132. In the context of the present disclosure, update parameters may be determined based on a variety of model optimization approaches that are currently known and/or will be developed in the future. For example, a loss function may be constructed based on a difference between a label in the training data and a predicted value obtained based on the training data, thereby determining an update gradient caused by the loss function. In this case, the update gradient of respective sub-models may be used as an update parameter to update respective sub-models.

According to an example implementation of the present disclosure, the update operation may be performed at the local compute node corresponding to the sub-model. For example, the sub-model 130 is located at the compute node 210, and thus the sub-model 130 may be optimized at the compute node 210 using the update parameter of the sub-model 130. For another example, the sub-model 132 is located at the compute node 220, and therefore, the update parameter of the sub-model 132 need to be transmitted to the compute node 220, and then the sub-model 132 is updated at the compute node 220. Here, the update parameter only relates to the update gradient and only has a small amount of data, thus not causing excessive network burden.

With example implementations of the present disclosure, only sub-models with smaller amounts of data need to be transmitted in each training phase, without having to transmit massive amounts of training data. After the update parameter is determined, the update parameter only needs to be returned to the local compute node where respective sub-models are located, so as to update respective sub-models at respective local nodes. In this way, the network bandwidth overhead involved during the training process may be greatly reduced.

According to an example implementation of the present disclosure, at respective compute nodes, a transmission process of obtaining the sub-model and returning the update parameter occupies network bandwidth resources, and a computation process of determining the update parameter of the sub-model occupies computing resources. In this case, the transmission process and the computation process do not conflict and may be performed in parallel, thereby further improving the efficiency of the training process.

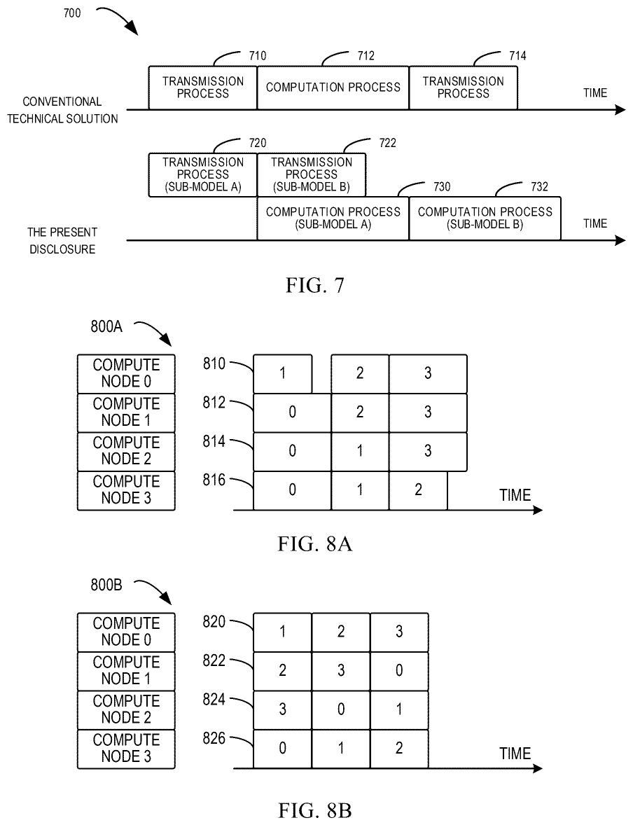

FIG. 7 illustrates a block diagram 700 of a comparison for a plurality of training processes according to some implementations of the present disclosure. The upper part of FIG. 7 illustrates a training process of a conventional technical solution, and the lower part of FIG. 7 illustrates a training process based on an example implementation of the present disclosure. In the conventional technical solution, there is a strong timing relationship between a transmission process 710 configured to obtain training data, a computation process 712 configured to determine an update parameter, and a transmission process 714 configured to return the update parameter, that is the described processes may only be performed in series, which results in a large waiting delay at each compute node.

In the technical solution of the present disclosure, since there is no resource contention in the transmission process and the computation process, they may be performed in parallel. Processing for respective sub-models may be performed in parallel, as illustrated in FIG. 7, a transmission process 720 for sub-model A and a transmission process 722 for sub-model B may be performed. In parallel with the transmission process, a computation process 730 of determining an update parameter of the sub-model A and a computation process 732 of determining an update parameter of the sub-model B may be performed. In this way, the parallelism of the transmission process and the computation process at the compute node may be greatly improved, thereby improving the overall performance of the training process.

It will be appreciated that there is generally a limit to the bandwidth of an access interface of a storage device of the compute node, and when a plurality of compute nodes simultaneously obtain a sub-model from a specific compute node, the data access performance of the specific compute node will be degraded and delays may occur. FIG. 8A illustrates a block diagram 800A of a timing of transmission of a sub-model among a plurality of compute nodes according to some implementations of the present disclosure. The left side of FIG. 8A illustrates 4 compute nodes (denoted as compute nodes 0, 1, 2, 3, respectively) in the computing device, and the right side of FIG. 8A illustrates the time overhead of transmitting a sub-model among a plurality of compute nodes.

Specifically, the numbers in the blocks on the right side represent the numbers of the compute nodes where the sub-model is located, for example, block 810 represents the time overhead for compute node 0 to read the sub-model from compute node 1. Block 812 represents the time overhead for compute node 1 to read the sub-model from compute node 0. Block 814 represents the time overhead for compute node 2 to read the sub-model from compute node 0, and block 816 represents the time overhead for compute node 3 to read the sub-model from compute node 0. Since compute nodes 1-3 read the sub-model in compute node 0 simultaneously, this results in contentions occurring when compute node 0 is accessed, and the time overhead for blocks 812, 814, and 816 increases, which is higher than that of block 810 (without contention).

According to an example implementation of the present disclosure, in consideration of the aforementioned contention problem, simultaneously reading a sub-model from the memory of the same compute node may be avoided as much as possible. In other words, where a plurality of compute nodes need to read a sub-model from the same compute node, the plurality of compute nodes may be ordered and read in order. In this way, the problem of the plurality of compute nodes competing for the data access interface of the memory during the reading process may be avoided.

Specifically, it is assumed that the sub-model 132 is located at the compute node 220 in the computing device 450. If a third compute node in the computing device 450 also requests to obtain the sub-model 132, if a request to read the sub-model 132 is received from the third compute node, the order in which the sub-model 132 is read by the compute node 210 and the third compute node, respectively, may be determined. For example, the compute node 210 may be allowed to read first, and then the third compute node is allowed to read. At this point, the sub-model 132 may be read by the compute node 210 based on the aforementioned order to write the read sub-model to the memory 412 of the compute node 210. The sub-model 132 may then be read by the third compute node to write the read sub-model to the memory of the third compute node.

It will be appreciated that reading a sub-model between compute nodes other than compute nodes 0 and 1 is not affected when compute node 0 reads the sub-model from compute node 1. At this point, read operations among the plurality of compute nodes may be dispersed as far as possible, and the read operations that do not generate access interface contention may be performed in parallel. FIG. 8B illustrates a block diagram 800B of the timing of transmission of a sub-model among a plurality of compute nodes according to some implementations of the present disclosure. In FIG. 8B, as illustrated by block 820, compute node 0 may read the sub-model in compute node 1. In parallel with block 820, compute node 1 may read the sub-model in compute node 2 at block 822; At block 824, compute node 2 may read the sub-model in compute node 3; and at block 826, compute node 3 may read the sub-model in compute node 0. At this point, respective read operations may be independently performed without contention, and thus the time overhead of the training phase may be further reduced.

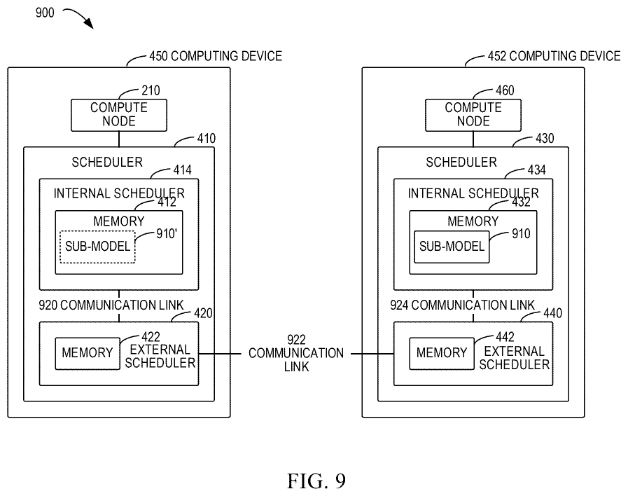

Having described the case where the sub-model is obtained from compute nodes located in the same computing device above, alternatively, and/or in addition, sub-models may be obtained from compute nodes located in different computing devices. FIG. 9 illustrates a block diagram 900 of a process for obtaining a sub-model from compute nodes located in different computing devices according to some implementations of the present disclosure. As shown in FIG. 9, the compute node 210 in the computing device 450 may send a request to a scheduler 410 to obtain a sub-model 910 in the memory 432 of the compute node 460 in another computing device 452. At this point, the scheduler 410 may invoke the external scheduler 420 to obtain the sub-model 910 from the computing device 452 and store it into the memory 412.

In particular, the external scheduler 440 in the computing device 452 may read the sub-model 910 from the memory 432 and store it to the memory 442 via a second type of link 924 for reading by the external scheduler 420. The external scheduler 420 in the computing device 450 may obtain the sub-model 910 from the computing device 452 to the computing device 450 via the first type of communication link 922 between the computing device 450 and the computing device 452. Further, the read sub-model 910 may be written to the memory 412 via a second type of link 920 to form a sub-model 910′. At this point, the plurality of schedulers cooperate together to read sub-models from the memory of the compute nodes located in the different computing devices.

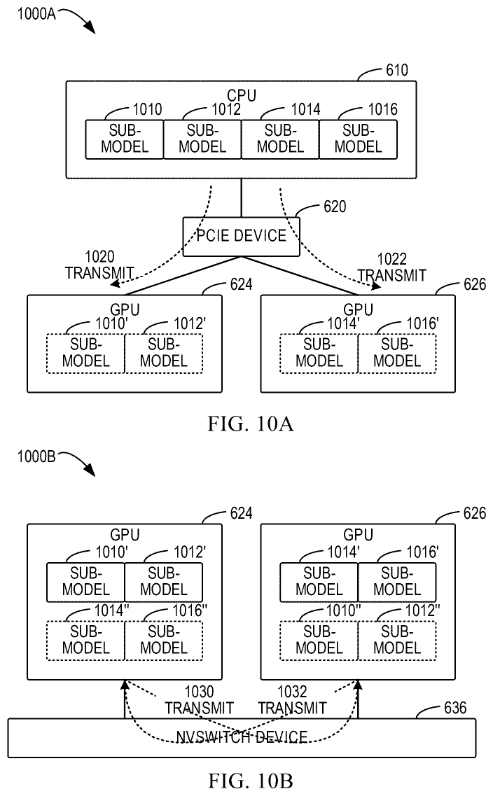

During the training process, respective compute nodes in the computing device 450 may require a large number of models from the computing device 452, therefore a plurality of sub-models may be obtained in advance from the computing device 452 at the beginning of respective training phases. It will be appreciated that different types of communication links in the computing system may have different speeds, in which case communication links with higher transmission speeds may be utilized preferentially. A block diagram of a process of obtaining sub-models from different computing devices is described with respect to FIG. 10A and FIG. 10B.

FIG. 10A illustrates a block diagram 1000 A of a first phase of a process of obtaining a plurality of sub-models from different computing devices according to some implementations of the present disclosure. As shown in the figure, the current computing device includes a CPU 610, GPUs 624 and 626 (connected with the CPU 610 via a PCIE device 620). It is assumed that both GPUs 624 and 626 expect to obtain sub-models 1010, 1012, 1014, and 1016 from another computing device, a plurality of sub-models may be obtained from another computing device via the first type of communication link between the current computing device and another computing device. At this point, the obtained plurality of sub-models 1010, 1012, 1014, and 1016 may be stored in the CPU 610.

Further, the GPU 624 may read sub-models 1010, 1012, 1014, and 1016 (via the PCIE device 620) using the second type of communication link and store them locally to the GPU 624. In addition, the GPU 626 may read sub-models 1010, 1012, 1014, and 1016 (via the PCIE device 620) using the second type of communication link and store them locally to the GPU 626. However, the transmission speed of the PCIE device 620 is not satisfactory, and a problem of insufficient bandwidth will occur when a large number of sub-models are transmitted, resulting in an increased waiting time.

According to an example implementation of the present disclosure, a third type of communication link between two GPUs may be utilized, thereby improving the efficiency of obtaining a sub-model. Specifically, the plurality of sub-models 1010, 1012, 1014, and 1016 may be divided into two groups: for example, a first group including sub-models 1010 and 1012, and a second group including sub-models 1014 and 1016. As shown by an arrow 1020 in FIG. 10A, the sub-models of the first group may be transmitted from the CPU 610 to the GPU 624 for storage of sub-models 1010′ and 1012′ (that is, copies of sub-models 1010 and 1012) in the GPU 624. As shown by an arrow 1022, the sub-models of the second group may be transmitted from the CPU 610 to the GPU 626 to store sub-models 1014′ and 1016′ (that is, copies of sub-models 1014 and 1016) in the GPU 626.

FIG. 10B illustrates a block diagram 1000B at a second phase of the process of obtaining a plurality of sub-models from different computing devices according to some implementations of the present disclosure. As shown in FIG. 10B, a third type of communication link between GPUs 624 and 626 may be utilized (for example, via an NVSwitch device 636) to transmit sub-models between GPUs 624 and 626. As shown by an arrow 1030, sub-models 1014′ and 1016′ may be transmitted from the GPU 626 to the GPU 624 via the NVSwitch device 636 to form sub-models 1014″ and 1016″. As shown by an arrow 1032, sub-models 1010′ and 1012′ may be transmitted from the GPU 624 to the GPU 626 via the NVSwitch device 636 to form sub-models 1010″ and 1012″. At this point, GPUs 624 and 626 will have all of the desired sub-models.

It will be appreciated that the transmission speed of the third type of communication link is much higher than the transmission speed of the second type of communication link. With example implementations of the present disclosure, a sub-model may be preferentially obtained using a communication link with a faster transmission speed. It is assumed that the transmission speed of the third type of communication link is 1000 times (or other multiples) the transmission speed of the second type of communication link, and the time for transmitting a sub-model from the CPU to the GPU is 1 second (or other length of time). In the conventional case where sub-models are transmitted directly from the CPU to the two GPUs 624 and 626, respectively, 8 sub-models need to be transmitted and the time overhead is 8 seconds. When the method described above is used, only 4 sub-models need to be transmitted from the CPU to the GPU, and the corresponding time overhead is 4 seconds. Further, 4 sub-models need to be transmitted via the high-speed third type of communication link, the corresponding time overhead is 1/1000*4=0.004 seconds. At this point, the overall time overhead is 4+0.004=4.004 seconds, which is much less than the conventional 8 seconds. In this way, the time overhead of obtaining sub-models may be further reduced, thereby improving the efficiency of the training process.

It will be appreciated that although the above only illustrates a situation where the computing device includes two compute nodes, alternatively and/or in addition, in addition to the first compute node and the second compute node described above, the computing device may further include the third compute node, and the third sub-model may be deployed at the third compute node. At this point, a similar training process may be performed at the third node.

In particular, at the third compute node, a third set of training data for training the machine learning model may be received. Here, the third set of training data may be different from the first set of training data. Further, the second sub-model may be obtained from the second compute node. The third set of training data may be input to the first sub-model and the obtained second sub-model, respectively, to determine an update parameter for updating the first sub-model (for example, referred to as a third update parameter) and an update parameter for updating the second sub-model (for example, referred to as a fourth update parameter). Further, the fourth update parameter may be transmitted to the local compute node of the second sub-model (that is, the second compute node).

It will be appreciated that, depending on the location of the second compute node on which the second sub-model located, the process of transmitting the update parameter herein may involve transmitting the update parameter to compute nodes located in the same computing device, and transmitting the update parameter to compute nodes located in different computing devices. The process of transmitting the update parameter of the sub-model is the reverse of the process of obtaining the sub-model described above, and the internal scheduler and/or the external scheduler may be invoked in a similar manner, respectively, and the update parameter is transmitted via the first, second and/or third types of communication links.

In this case, the determined update parameter needs to be separately transmitted from the first compute node and the third compute node to the second compute node. When the computing device includes more compute nodes, the foregoing backhaul process needs to occupy more bandwidth resources in the computing system. To further reduce the transmission load, a combined update parameter for updating the second sub-model may be determined based on the second update parameter and the fourth update parameter. For example, an average of the two update parameters may be determined and transmitted to the second compute node.

Assuming that the computing device includes 8 GPUs, then 8 update parameters may be determined at the 8 GPUs separately, and then the 8 update parameters need to be transmitted back to the local node of the sub-model. Where the update parameter relates to the update gradient, the second compute node may optimize the second sub-model based on an average of the update gradient determined at the 8 compute nodes. In this way, a transmission overhead related to gradient backhaul may be reduced to ⅛ of an original transmission overhead, thereby further reducing an invalid transmission overhead of the training process, and further improving the overall performance of the training process.

In accordance with an example implementation of the present disclosure, a similar process may be performed at each compute node. Assuming that the second set of training data at the second compute node needs to invoke the first sub-model, the second set of training data for training the machine learning model may be received at the second compute node, and the first sub-model may be obtained from the first compute node. Further, the second set of training data may be input to the obtained first sub-model and second sub-model, respectively, to determine the update parameter for updating the first sub-model (for example, referred to as a fifth update parameter) and the update parameter for updating the second sub-model (for example, referred to as a sixth update parameter). The sixth update parameter may then be transmitted to the local first compute node of the first sub-model.

Where the update parameters have been obtained, the sub-models may be updated at the local compute nodes at which the respective sub-models are located. In particular, the first sub-model may be updated at the first compute node with the first update parameter, and the second sub-model may be updated at the second compute node with the second update parameter. It will be appreciated that the respective sub-models may be updated based on a variety of update means currently known and/or to be developed in the future. For example, where the update parameter relates to the update gradient, the parameters of the respective sub-models may be updated along the direction of the update gradient based on a predetermined step size.

It will be appreciated that although the training process is described above with only the training phase as an example, alternatively and/or in addition, the machine learning model may be trained iteratively in a plurality of phases based on the processes described above. A training stop condition may be predefined, for example, the training may be stopped when a predetermined number of iterations has been reached, the training may be stopped when a threshold convergence condition has been reached, or the like.

By using example implementations of the present disclosure, compared with the existing “expert-centric” technical solution, the proposed “data-centric” technical solution may greatly reduce the amount of data to be transmitted. In the following, the data transmission volume of the two training processes will be compared through specific equations. The machine learning model may be implemented based on a hybrid expert system, and each sub-module may be implemented using a Feed Forward Network (FFN) model. Each FFN model may include two linear layers, a first linear layer may refer to a H*4H dimension, and a second linear layer may refer to a 4H*H dimension, where the dimension of the FFN model is 8H². Assuming E sub-models are included at each compute node, then each computing device has mE sub-models. In the worst case, each computing device needs to broadcast mE sub-models to the rest n−1 computing devices. In this case, in the “data-centric” solution, the traffic for transmitting the sub-model may be expressed as:

$${Comm}_{DC} = 8 {H}^{2} Em ( n - 1 ) \qquad Equation 1$$

In the “expert-centric” solution, the location of the sub-model is fixed and the training data is transmitted. Assuming that each compute node generates T training data, then a computing device that includes m compute nodes will generate mT training data. Assuming that the training data is evenly distributed, then

$$\frac{n - 1}{n}$$

training data is transmitted to other computing devices, and at this point, the communication volume of transmitting the training data may be expressed as:

$${Comm}_{EC} = 2 mHT \frac{n - 1}{n} \qquad Equation 2$$

Based on Equations 1 and 2, it can be determined that the ratio of the data transmission volumes involved in the two training processes is:

$$R = \frac{{Comm}_{EC}}{{Comm}_{DC}} = \frac{T}{4 nHE} \qquad Equation 3$$

At this point, the number of training data T depends on a batch size B, a sequence length S, and a gating parameter k in the hybrid expert model. At this time, the Equation 3 may be rewritten as the following Equation 4:

$$R = \frac{BSk}{4 NHE} \qquad Equation 4$$

In a specific application environment, a specific numerical value may be set for respective symbols in the equation: a batch size B=128, a sequence length S=1024, a gating parameter k=2, a dimension H=768, two computing devices exist (n=2), and 1 sub-model is deployed at each compute node. In this case, R=42.67 may be determined based on Equation 4. In other words, compared with the existing “expert-centric” solution, by adopting the proposed “data-centric” solution, the data transmission volume will be reduced to about 1/42 of the original data transmission volume.

The process for training a machine learning model has been described above. Using the above process, the efficiency of the training process may be improved from a number of aspects. The above process supports fine-grained asynchronous communications, in other words, a process of transmitting the sub-model and a process of computing update parameters may be performed in parallel at the granularity of the sub-model. Further, multiple types of communication links support layered communications, and sub-models located in the compute nodes of other computing devices may be pulled in advance to the current computing device in order to share the sub-model via high-speed communication links among a plurality of compute nodes of the current computing device. With example implementations of the present disclosure, the required sub-models may be obtained in advance at the starting time point of respective training phases.

### Example Processes

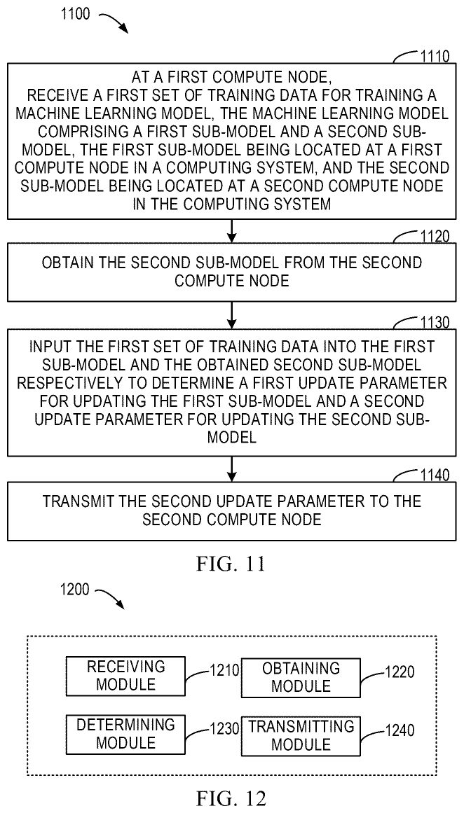

Specific processes for training a machine learning model have been described above. Hereinafter, a corresponding method is described with reference to FIG. 11, which illustrates a flowchart of a method 1100 for training a machine learning model according to some implementations of the present disclosure. Herein, the machine learning model comprising a first sub-model and a second sub-model, the first sub-model being located at a first compute node in a computing system, and the second sub-model being located at a second compute node in the computing system. At block 1110, at a first compute node, a first set of training data for training the machine learning model is received; at block 1120, the second sub-model is obtained from the second compute node; at block 1130, the first set of training data is input into the first sub-model and the obtained second sub-model respectively to determine a first update parameter for updating the first sub-model and a second update parameter for updating the second sub-model; and at block 1140, the second update parameter is transmitted to the second compute node.

According to an example implementation of the present disclosure, obtaining the second sub-model comprises: at a starting time point of a training phase for training the machine learning model, obtaining the second sub-model from the second compute node.

According to an example implementation of the present disclosure, obtaining the second sub-model comprises: in response to determining that both the first compute node and the second compute node are located at a first computing device of the computing system, writing the second sub-model from a memory of the second compute node to a memory of the first compute node.

According to an example implementation of the present disclosure, writing the second sub-model to the memory of the first compute node comprises: based on memory capacity of the memory of the first compute node and size of the second sub-model, determining a threshold number of sub-models that the memory of the first compute node can accommodate; and in response to determining that a number of sub-models in the memory of the first compute node is below the threshold number, writing the second sub-model to the memory of the first compute node.

According to an example implementation of the present disclosure, the memory of the first compute node comprises a third sub-model of the machine learning model, and the method further comprises: in response to determining that the number of sub-models in the memory of the first compute node is equal to the threshold number, in response to determining that a third update parameter for the third sub-model in the memory of the first compute node has been transmitted, releasing the third sub-model from the memory of the first compute node; and writing the second sub-model to the memory of the first compute node.

According to an example implementation of the present disclosure, the first computing device further comprises a third compute node, and writing the second sub-model to the memory of the first compute node further comprises: in response to receiving a request from the third compute node to read the second sub-model, determining an order in which the second sub-model is to be read by the first compute node and the third compute node, respectively; and reading, based on the order, the second sub-model by the first compute node and the third compute node, respectively, to write the second sub-model to the memory of the first compute node and the memory of the third compute node.

According to an example implementation of the present disclosure, obtaining the second sub-model further comprises: in response to determining that the first compute node and the second compute node are respectively located in the first computing device and a second computing device in the computing system, writing the second sub-model from a memory of the second computing device to a memory of the first computing device via a first type of communication link between the first computing device and the second computing device; and writing the second sub-model from the memory of the first computing device to the memory of the first compute node via a second type of communication link between the first computing device and the first compute node.

According to an example implementation of the present disclosure, the first computing device further comprises a third compute node, and the method further comprises: in response to a request from the third compute node, writing the second sub-model from the memory of the first computing device to a memory of the third compute node via a second type of communication link between the first computing device and the third compute node; and writing the second sub-model from the memory of the third compute node to the memory of the first compute node via a third type of communication link between the first compute node and the third compute node.

According to an example implementation of the present disclosure, the first compute node, the second compute node, and the third compute node are graphics processing units.

According to an example implementation of the present disclosure, the second type of the communication link has a lower speed than the third type of the communication link.

According to an example implementation of the present disclosure, the method 1100 further comprises: at the second compute node, receiving a second set of training data for training the machine learning model; obtaining the first sub-model from the first compute node; inputting the second set of training data into the obtained first sub-model and the second sub-model respectively to determine a fifth update parameter for updating the first sub-model and a sixth update parameter for updating the second sub-model; and transmitting the sixth update parameter to the first compute node.

According to an example implementation of the present disclosure, the method 1100 further comprises: at a third compute node of the first computing device, receiving a third set of training data for training the machine learning model; obtaining the second sub-model from the second compute node; inputting the third set of training data into the first sub-model and the obtained second sub-model respectively to determine a third update parameter for updating the first sub-model and a fourth update parameter for updating the second sub-model; and transmitting the fourth update parameter to the second compute node.

According to an example implementation of the present disclosure, transmitting the second update parameter and the fourth update parameter to the second compute node further comprises: determining, based on the second update parameter and the fourth update parameter, a combined update parameter for updating the second sub-model; and transmitting the combined update parameter to the second compute node.

According to an example implementation of the present disclosure, the machine learning model is implemented based on a hybrid expert system, and the first sub-model and the second sub-model is a first expert model and a second expert model, respectively, in the hybrid expert system.

According to an example implementation of the present disclosure, the method 1100 further comprises updating, at the first compute node, the first sub-model with the first update parameter, and updating, at the second compute node, the second sub-model with the second update parameter.

### Example Apparatus and Device

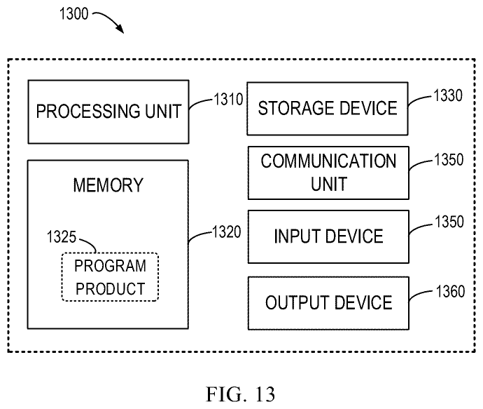

FIG. 12 illustrates a block diagram of an apparatus 1200 for training a machine learning model, according to some implementations of the present disclosure. The machine learning model comprises a first sub-model and a second sub-model, the first sub-model is located at a first compute node in a computing system, and the second sub-model is located at a second compute node in the computing system. The apparatus comprises: a receiving module 1210 configured to receive a first set of training data for training the machine learning model; an obtaining module 1220 configured to obtain the second sub-model from the second compute node; a determining module 1230 configured to input the first set of training data into the first sub-model and the obtained second sub-model respectively to determine a first update parameter for updating the first sub-model and a second update parameter for updating the second sub-model; and a transmitting module 1240 configured to transmit the second update parameter to the second compute node.

According to an example implementation of the present disclosure, the obtaining module 1220 comprises: an initialization module configured to at a starting time point of a training phase for training the machine learning model, obtain the second sub-model from the second compute node.

According to an example implementation of the present disclosure, the obtaining module 1220 comprises: a writing module configured to, in response to determining that both the first compute node and the second compute node are located at a first computing device of the computing system, write the second sub-model from a memory of the second compute node to a memory of the first compute node.

According to an example implementation of the present disclosure, the writing module comprises: a threshold determining module configured to, based on memory capacity of the memory of the first compute node and size of the second sub-model, determine a threshold number of sub-models that the memory of the first compute node can accommodate; and a comparison module configured to, in response to determining that a number of sub-models in the memory of the first compute node is below the threshold number, write the second sub-model to the memory of the first compute node.

According to an example implementation of the present disclosure, the memory of the first compute node comprises a third sub-model of the machine learning model, and the apparatus further comprises: a releasing module configured to, in response to determining that the number of sub-models in the memory of the first compute node is equal to the threshold number, in response to determining that a third update parameter for the third sub-model in the memory of the first compute node has been transmitted, release the third sub-model from the memory of the first compute node; and a sub-module writing module configured to write the second sub-model to the memory of the first compute node.

According to an example implementation of the present disclosure, the first computing device further comprises a third compute node, and the writing module further comprises: an order determining module configured to, in response to receiving a request from the third compute node to read the second sub-model, determine an order in which the second sub-model is to be read by the first compute node and the third compute node, respectively; and an order-based writing module configured to read, based on the order, the second sub-model by the first compute node and the third compute node, respectively, to write the second sub-model to the memory of the first compute node and the memory of the third compute node.

According to an example implementation of the present disclosure, the obtaining module 1220 further comprises a first writing module configured to, in response to determining that the first compute node and the second compute node are respectively located in the first computing device and a second computing device in the computing system, write the second sub-model from a memory of the second computing device to a memory of the first computing device via a first type of communication link between the first computing device and the second computing device; and a second writing module configured to write the second sub-model from the memory of the first computing device to the memory of the first compute node via a second type of communication link between the first computing device and the first compute node.

According to an example implementation of the present disclosure, the first computing device further comprises a third compute node, and the second writing module is further configured to: in response to a request from the third compute node, write the second sub-model from the memory of the first computing device to a memory of the third compute node via a second type of communication link between the first computing device and the third compute node; and a third writing module configured to write the second sub-model from the memory of the third compute node to the memory of the first compute node via a third type of communication link between the first compute node and the third compute node.

According to an example implementation of the present disclosure, the first compute node, the second compute node, and the third compute node are graphics processing units.

According to an example implementation of the present disclosure, the second type of the communication link has a lower speed than the third type of the communication link.

According to an example implementation of the present disclosure, the receiving module 1210 is further configured to at the second compute node, receive a second set of training data for training the machine learning model; the obtaining module 1220 is configured to obtain the first sub-model from the first compute node; the determining module 1230 is configured to input the second set of training data into the obtained first sub-model and the second sub-model respectively to determine a fifth update parameter for updating the first sub-model and a sixth update parameter for updating the second sub-model; and the transmitting module 1240 is configured to transmitting the sixth update parameter to the first compute node.

According to an example implementation of the present disclosure, the receiving module 1210 is further configured to at a third compute node of the first computing device, receive a third set of training data for training the machine learning model; the obtaining module 1220 is further configured to obtain the second sub-model from the second compute node; the determining module 1230 is further configured to input the third set of training data into the first sub-model and the obtained second sub-model respectively to determine a third update parameter for updating the first sub-model and a fourth update parameter for updating the second sub-model; and the transmitting module 1240 is further configured to transmit the fourth update parameter to the second compute node.

According to an example implementation of the present disclosure, the transmitting module 1240 further comprises: a combination module configured to determine, based on the second update parameter and the fourth update parameter, a combined update parameter for updating the second sub-model; and a combination parameter transmitting module configured to transmit the combined update parameter to the second compute node.

According to an example implementation of the present disclosure, the machine learning model is implemented based on a hybrid expert system, and the first sub-model and the second sub-model is a first expert model and a second expert model, respectively, in the hybrid expert system.

According to an example implementation of the present disclosure, the apparatus 1200 further comprises: an updating module configured to update, at the first compute node, the first sub-model with the first update parameter, and update, at the second compute node, the second sub-model with the second update parameter.

FIG. 13 illustrates a block diagram of an electronic device 1300 in which one or more implementations of the present disclosure may be implemented. It should be appreciated that the electronic device 1300 shown in FIG. 13 is merely exemplary and should not constitute any limitation on the functionality and scope of the embodiments described herein.

As shown in FIG. 13, the electronic device 1300 is in the form of a general-purpose computing device. Components of the electronic device 1300 may include but are not limited to, one or more processors or processing units 1310, a memory 1320, a storage device 1330, one or more communication units 1340, one or more input devices 1350, and one or more output devices 1360. The processing unit 1310 may be an actual or virtual processor and can perform various processes according to programs stored in the memory 1320. In a multiprocessor system, a plurality of processing units perform computer-executable instructions in parallel to improve the parallel processing capability of the electronic device 1300.

The electronic device 1300 typically includes a number of computer storage mediums. Such mediums may be any available medium that is accessible to the electronic device 1300, including, but not limited to, volatile and non-volatile medium, removable and non-removable medium. The memory 1320 may be a volatile memory (for example, a register, cache, a random access memory (RAM)), a non-volatile memory (for example, a read-only memory (ROM), an electrically erasable programmable read-only memory (EEPROM), a flash memory), or some combination thereof. The storage device 1330 may be a removable or non-removable medium and may include a machine-readable medium such as a flash drive, a magnetic disk, or any other medium that may be used to store information and/or data (for example, training samples for training) and that may be accessed within the electronic device 1300.

The electronic device 1300 may further include an additional removable/non-removable, volatile/nonvolatile storage medium. Although not shown in FIG. 13, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data medium interfaces. The memory 1320 may include a computer program product 1325 having one or more program modules configured to perform the various methods or actions of the various embodiments of the present disclosure.

The communication unit 1340 implements communication with other electronic devices through a communication medium. In addition, functions of components of the electronic device 1300 may be implemented by a single computing cluster or a plurality of computing machines, and these computing machines can communicate through a communication connection. Thus, the electronic device 1300 may operate in a networked environment using logical connections to one or more other servers, network personal computers (PCs), or another network node.

The input device 1350 may be one or more input devices such as a mouse, a keyboard, a trackball, or the like. The output device 1360 may be one or more output devices such as a display, a speaker, a printer, or the like. The electronic device 1300 may also communicate with one or more external devices (not shown) through the communication unit 1340 as needed, such as a storage device, a display device, or the like, with one or more devices that enable a user to interact with the electronic device 1300, or with any device (for example, a network card, a modem, or the like) that enables the electronic device 1300 to communicate with one or more other electronic devices. Such communication may be performed via an input/output (I/O) interface (not shown).

According to an example implementation of the present disclosure, a computer-readable storage medium is provided, on which a computer-executable instruction is stored, wherein the computer-executable instruction is executed by a processor to implement the above-described method. According to an example implementation of the present disclosure, there is also provided a computer program product, which is tangibly stored on a non-transitory computer-readable medium and comprises a computer-executable instruction that is executed by a processor to implement the method described above.

Aspects of the present disclosure are described herein with reference to flowchart illustrations and/or block diagrams of the method, apparatus, device, and computer program product implemented in accordance with the present disclosure. It will be understood that each block of the flowchart and/or block diagrams, and combinations of blocks in the flowchart and/or block diagrams, can be implemented by computer-readable program instructions.

These computer-readable program instructions may be provided to a processing unit of a general-purpose computer, special-purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in one or more blocks in the flowchart and/or block diagram.

The computer-readable program instructions may be loaded onto a computer, other programmable data processing apparatus, or other devices, causing a series of operational steps to be performed on a computer, other programmable data processing apparatus, or other devices, to produce a computer-implemented process such that the instructions which executed on the computer, other programmable data processing apparatus, or other devices implement the functions/acts specified in one or more blocks in the flowchart and/or block diagram

The flowchart and block diagrams in the drawings illustrate the architecture, functionality, and operation of possible implementations of systems, methods, and computer program products according to various implementations of the present disclosure. In this regard, each block in the flowchart or block diagrams may represent a module, segment, or portion of an instruction that comprises one or more executable instructions for implementing the specified logical function. In some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the present disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

1. A method for training a machine learning model, the machine learning model comprising a first sub-model and a second sub-model, the first sub-model being located at a first compute node in a computing system, and the second sub-model being located at a second compute node in the computing system, and wherein the method comprises: at the first compute node,
receiving a first set of training data for training the machine learning model;
obtaining the second sub-model from the second compute node;
inputting the first set of training data into the first sub-model and the obtained second sub-model respectively to determine a first update parameter for updating the first sub-model and a second update parameter for updating the second sub-model; and
transmitting the second update parameter to the second compute node.

2. The method of claim 1, wherein obtaining the second sub-model comprises: at a starting time point of a training phase for training the machine learning model, obtaining the second sub-model from the second compute node.

3. The method of claim 1, wherein obtaining the second sub-model comprises:
in response to determining that both the first compute node and the second compute node are located at a first computing device of the computing system, writing the second sub-model from a memory of the second compute node to a memory of the first compute node.

4. The method of claim 3, wherein writing the second sub-model to the memory of the first compute node comprises:
based on memory capacity of the memory of the first compute node and size of the second sub-model, determining a threshold number of sub-models that the memory of the first compute node can accommodate; and
in response to determining that a number of sub-models in the memory of the first compute node is below the threshold number, writing the second sub-model to the memory of the first compute node.

5. The method of claim 4, wherein the memory of the first compute node comprises a third sub-model of the machine learning model, and the method further comprises: in response to determining that the number of sub-models in the memory of the first compute node is equal to the threshold number:
in response to determining that a third update parameter for the third sub-model in the memory of the first compute node has been transmitted, releasing the third sub-model from the memory of the first compute node; and
writing the second sub-model to the memory of the first compute node.

6. The method of claim 4, wherein the first computing device further comprises a third compute node, and writing the second sub-model to the memory of the first compute node further comprises:
in response to receiving a request from the third compute node to read the second sub-model, determining an order in which the second sub-model is to be read by the first compute node and the third compute node, respectively; and
reading, based on the order, the second sub-model by the first compute node and the third compute node, respectively, to write the second sub-model to the memory of the first compute node and the memory of the third compute node.

7. The method of claim 3, wherein obtaining the second sub-model further comprises: in response to determining that the first compute node and the second compute node are respectively located in the first computing device and a second computing device in the computing system,
writing the second sub-model from a memory of the second computing device to a memory of the first computing device via a first type of communication link between the first computing device and the second computing device; and
writing the second sub-model from the memory of the first computing device to the memory of the first compute node via a second type of communication link between the first computing device and the first compute node.

8. The method of claim 7, wherein the first computing device further comprises a third compute node, and the method further comprises:
in response to a request from the third compute node, writing the second sub-model from the memory of the first computing device to a memory of the third compute node via a second type of communication link between the first computing device and the third compute node; and
writing the second sub-model from the memory of the third compute node to the memory of the first compute node via a third type of communication link between the first compute node and the third compute node.

9. The method of claim 8, wherein the first compute node, the second compute node, and the third compute node are graphics processing units.

10. The method of claim 8, wherein the second type of the communication link has a lower speed than the third type of the communication link.

11. The method of claim 1, further comprising: at a third compute node of the first computing device,
receiving a third set of training data for training the machine learning model;
obtaining the second sub-model from the second compute node;
inputting the third set of training data into the first sub-model and the obtained second sub-model respectively to determine a third update parameter for updating the first sub-model and a fourth update parameter for updating the second sub-model; and
transmitting the fourth update parameter to the second compute node.

12. The method of claim 11, wherein transmitting the second update parameter and the fourth update parameter to the second compute node further comprises:
determining, based on the second update parameter and the fourth update parameter, a combined update parameter for updating the second sub-model; and
transmitting the combined update parameter to the second compute node.

13. The method of claim 1, further comprising: at the second compute node,
receiving a second set of training data for training the machine learning model;
obtaining the first sub-model from the first compute node;
inputting the second set of training data into the obtained first sub-model and the second sub-model respectively to determine a fifth update parameter for updating the first sub-model and a sixth update parameter for updating the second sub-model; and
transmitting the sixth update parameter to the first compute node.

14. The method of claim 1, wherein the machine learning model is implemented based on a hybrid expert system, and the first sub-model and the second sub-model is a first expert model and a second expert model, respectively, in the hybrid expert system.

15. The method of claim 1, further comprising: updating, at the first compute node, the first sub-model with the first update parameter, and updating, at the second compute node, the second sub-model with the second update parameter.

16. (canceled)

17. An electronic device, comprising:
at least one processing unit; and
at least one memory coupled to the at least one processing unit and storing an instruction for execution by the at least one processing unit, the instruction, when executed by the at least one processing unit, causing the device to perform operations comprising:
receiving a first set of training data for training the machine learning model;
obtaining the second sub-model from the second compute node;
inputting the first set of training data into the first sub-model and the obtained second sub-model respectively to determine a first update parameter for updating the first sub-model and a second update parameter for updating the second sub-model; and
transmitting the second update parameter to the second compute node.

18. A non-transitory computer-readable storage medium having stored thereon a computer program which, when executed by a processor, performs operations comprising:
receiving a first set of training data for training the machine learning model;
obtaining the second sub-model from the second compute node;
inputting the first set of training data into the first sub-model and the obtained second sub-model respectively to determine a first update parameter for updating the first sub-model and a second update parameter for updating the second sub-model; and
transmitting the second update parameter to the second compute node.

19. The electronic device of claim 17, wherein obtaining the second sub-model comprises: at a starting time point of a training phase for training the machine learning model, obtaining the second sub-model from the second compute node.

20. The electronic device of claim 17, wherein obtaining the second sub-model comprises:
in response to determining that both the first compute node and the second compute node are located at a first computing device of the computing system, writing the second sub-model from a memory of the second compute node to a memory of the first compute node.

21. The electronic device of claim 20, wherein writing the second sub-model to the memory of the first compute node comprises:
based on memory capacity of the memory of the first compute node and size of the second sub-model, determining a threshold number of sub-models that the memory of the first compute node can accommodate; and
in response to determining that a number of sub-models in the memory of the first compute node is below the threshold number, writing the second sub-model to the memory of the first compute node.
